(19) United States
(12) Patent Application Publication
(10) Pub. No.: US 2011/0153145 A1
(43) Pub. Date: Jun. 23, 2011

(54) METHOD FOR DETECTING ERRORS IN A CONTROL UNIT

(76) Inventor: Guenter KETTENACKER, Steinheim (DE)

(21) Appl. No.: 12/965,386

(22) Filed: Dec. 10, 2010

(30) Foreign Application Priority Data
Dec. 18, 2009 (DE) 10 2009 054 959.5

(51) Int. Cl. G06F 7/00

(52) U.S. Cl. 701/29

(57) ABSTRACT

A method is described for detecting errors in a control unit for controlling and/or regulating an engine in a vehicle, in which the presence of a faulty state of the engine and/or the vehicle is detected, a difference between at least one instantaneous value of an operating variable and a limiting value provided for this operating variable being formed multiple times, the formed differences being added to a sum, and the faulty state being evaluated as an error if the sum exceeds a predefinable threshold value.

### RELATED APPLICATION INFORMATION

The present application claims priority to and the benefit of German patent application no. 10 2009 054 959.5, which was filed in Germany on Dec. 18, 2009, the disclosure of which is incorporated herein by reference.

### FIELD OF THE INVENTION

The present invention relates to a method for detecting errors in a control unit for controlling and/or regulating an engine in a vehicle, in which a faulty state of the engine and/or the vehicle is detected. The present invention also relates to a control unit for controlling and/or regulating an engine in a vehicle, and to a memory medium and a computer program.

### BACKGROUND INFORMATION

To safely and reliably operate a vehicle, it is desirable, in principle, to detect errors as quickly and yet as reliably as possible. According to a known method, a timer which determines a predefinable debounce time is activated when a faulty state occurs. If the faulty state continues without interruption during the debounce time, an error is concluded upon expiration of the debounce time, i.e., it is determined that the faulty state is to be regarded as an error, and troubleshooting is carried out if necessary. If the faulty state disappears only temporarily during the debounce time, the timer is reset and reactivated only if the faulty state reoccurs. According to another known method, a counter is incremented during the presence of a faulty state. If the faulty state is no longer present, the counter is decremented again. If the counter content exceeds a predefinable threshold value, an error may be concluded, provided that faulty state occurs at a frequency of at least 50%.

### SUMMARY OF THE INVENTION

An object of the exemplary embodiments and/or exemplary methods of the present invention is achieved by an aforementioned method having the features of the characterizing part by taking into account the severity of an error in assessing whether a faulty state, which is also referred to below as an error state, is to be regarded as an error and thus enables serious error states to be particularly quickly evaluated as errors. An error state is then evaluated or detected as an error if a limiting value is exceeded at least on average, taking into account the severity and duration of the error. The method according to the present invention thus makes it possible to detect an error both quickly and reliably.

The exemplary embodiments and/or exemplary methods of the present invention are directed to the finding that even serious error states are not continuously present in every case. This may be due to error-specific reasons, on the one hand, and faults may occur during the transmission of the error state to a control unit, on the other hand. Moreover, the invention takes into account the fact that error states often do not relate to the presence of an operating variable per se, but rather concern the exceedance of a limiting value provided for this operating variable.

It is understood that operating variables and limiting values may be converted to secondary variables, as is general practice, and these secondary variables may then be used for the further method steps. Secondary variables are, for example, electrical voltages and/or numerical variables which may be transmitted via a data line and/or processed in a control unit. To facilitate comprehension, however, secondary variables of this type are not expressly mentioned below.

According to the exemplary embodiments and/or exemplary methods of the present invention, a difference between an instantaneous value of the operating variable and a variable characterizing the limiting value is formed multiple times, for example periodically using or as a function of a clock pulse of a control unit, synchronously using or as a function of a cyclical operation associated with the operating variable and/or as a function of a signal which is generated, for example, with the aid of a functionality provided in the control unit. As a result, the method is applicable to continuously present and/or changing operating variables, such as engine speeds, driving torques or fuel quantities, as well as to cyclically present operating variables, for example, injector activation times for fuel injection into internal combustion engines. The differences formed with the aid of the method are added to a sum, and the faulty state is evaluated as an error if the sum exceeds a predefinable threshold value. An integration of the formed differences is carried out thereby. In this way, temporary interruptions in the error state may essentially delay the detection of the error only to the extent that the duration of a temporary interruption is relative to the presence of an error state.

Due to the, for example, linear formation of the difference between the operating variable and the limiting value, significant amounts by which the operating variable exceeds the limiting value are incorporated into the sum to a correspondingly greater extent. In the event of significant exceedances, therefore, an error state may be correspondingly evaluated as an error more quickly without substantially limiting the reliability of detection. It is understood that the term “error” in this case may mean a non-critical variable or an event which is to be evaluated in each case on the basis of a presence or absence or with regard to the error severity.

The summation or integration of the difference proposed by the method may be carried out in nearly any manner. Methods of this type which are implemented, for example, by an analog circuit or with the aid of a numerical process in the control unit, are sufficiently well known.

The method may be used to monitor operating variables for the presence of error states, an error being concluded if they exceed (upper) limiting values or fall below (lower) limiting values.

In the present description of the exemplary embodiments and/or exemplary methods of the present invention, for the sake of simplicity, an error detection operation is illustrated by way of example with regard to the exceedance of an (upper) limiting value. If the fall below a lower limiting value is to be monitored, this may be achieved, for example, by performing a calculation using a negative sum and a negative threshold value or by the fact that the minuend and the subtrahend are suitably exchanged in the difference between the operating variable and the limiting value.

The method according to the present invention makes it possible, in particular, to also monitor one or more operating variables to determine whether the operating variable lies within a corridor formed by an upper limiting value and a lower limiting value. For example, a pressure in a high-pressure storage unit of a fuel system of a vehicle may be evaluated as an error when it exceeds a maximum pressure as well as when it falls below a minimum pressure. In this case, the sum is compared with both an upper threshold value and a lower threshold value, and the error state is qualified as an error if the sum leaves the corridor.

The method may be flexibly applied, in particular, if the threshold value is selected as a function of the operating variable. An implicit debounce time which characterizes the formation of the sum or the integral may be set thereby. This makes it possible to either set the speed or reliability of the error detection as a priority or to reach a suitable compromise between the two requirements. In this manner, it is possible to take into account, for example, how critical an operating variable is for the safe operation of the vehicle or how much an operating variable fluctuates during permissible normal operation.

The method makes it possible, in particular, to also specify a debounce time, the faulty state being evaluated as an error upon expiration of the debounce time. If the debounce time is set as an “implicit” debounce time, the error is detected using the sum or the integral, as described above. If the debounce time is set as an “explicit” debounce time, this corresponds to a fixed debounce time, which is not influenced when the limiting value is exceeded. Detecting an error as a function of the expiration of the explicit debounce time may be carried out parallel to the error detection carried out as a function of the integration. For example, the operating variable may be compared with the limiting value provided for this operating variable, and the exceedance of the limiting value is used as a criterion for qualifying the error state as an error without this taking into account the amount by which the limiting value is exceeded. In this way, even very slight exceedances may be quickly evaluated as errors if the exceedance is present without interruption during the course of the debounce time. The explicit specification of a debounce time further increases the reliability of the method and makes it possible to easily take into account, for example, specific conditions which require an explicit debounce time to be taken into account.

According to an advantageous specific embodiment of the method according to the present invention, the limiting value is varied. For the torque of an engine, for example, the limiting value may be a function of the rotational speed of the engine. Accordingly, the limiting value for the torque is varied during operation. As a result, an instantaneous torque may be compared with a continuously varied or updated limiting value, and the error detection may thus be carried out independently of the instantaneous operating state of the engine and/or of the vehicle, according to the present invention.

A torque, a pressure, an exhaust gas value, an engine speed, an engine performance, a temperature, a metered fuel quantity and/or a fuel injection activation time may be used as the operating variable. Important operating variables, which are present, for example, in a motor vehicle may thus be advantageously subjected to error detection.

One embodiment of the method provides that a variable characterizing the operating variable is added to a counter content, and a variable characterizing the limiting value is subtracted from the counter content. In this way, a counter which is implemented, for example, with the aid of a computer program as the integrator, may be advantageously used for error detection. An instantaneous counter content in this case corresponds to the sum or to an integral. In each case, the desired resolution or precision as well as a possible value range for the threshold value may be advantageously determined by the counter variable. Due to the addition and subtraction operations, it is not necessary to form the difference between the operating variable and the limiting value separately. A specific implementation may be carried out, for example, by one or more memory cells (bytes) of a random access memory (RAM) or with the aid of a special register within the control unit. A memory of this type is frequently already provided in a control unit, so that no additional costs are incurred.

In addition, it is proposed that a constant is also continuously added to the sum when the operating variable exceeds the limiting value. As a result, possible specific conditions may be met which, if necessary, specify fast error detection in cases in which a provided limiting value is only slightly exceeded. For example, 40% of a product of the operating variable multiplied by a sampling period may be added to the sum in addition to the difference between the operating variable and the limiting value in each addition step. This makes it possible to use the method with particular flexibility.

A further embodiment of the present invention provides that the sum is limited to the lower threshold value if the sum falls below a lower threshold value. For example, this lower threshold value is zero. This makes it possible to reliably prevent the sum or the integral from assuming large negative values during a longer phase in which the operating variable does not exceed the limiting value. The limitation to the lower threshold value also achieves the fact that the sum is formed starting at a defined initial state each time the limiting value is first exceeded.

A first measurement option for verifying the method provides that periodic switching between two memory pages of a memory of the control unit is carried out, the first memory page characterizing an okay state and the second memory page characterizing a not okay state. This makes it possible to generally simulate error states of the engine or the vehicle or other events. A second measurement option for verifying the method provides that multiple switching between a first and a second fuel quantity is carried out in a fuel quantity characteristics map, a variable characterizing the engine speed being largely constant. For example, an error state of a torque of the engine may be simulated in this manner.

The object is also achieved by a control unit, a computer program and a memory medium according to the other embodiments and descriptions herein. Advantageous refinements are specified in herein. Further features of the exemplary embodiments and/or exemplary methods of the present invention are specified in the following description of exemplary specific embodiments and in the drawings; the features may be important for the present invention both alone and in different combinations without explicit reference being again made thereto.

### BRIEF DESCRIPTION OF THE DRAWINGS

FIG. 1 shows two timing diagrams, including an operating variable, a limiting value and a sum.

FIG. 2 shows a diagram of a torque error over a debounce time.

FIG. 3 shows a schematic flow chart of the sequence of the method.

### DETAILED DESCRIPTION

The same reference numerals are used for functionally equivalent elements and variables in all figures, even in the case of different specific embodiments.

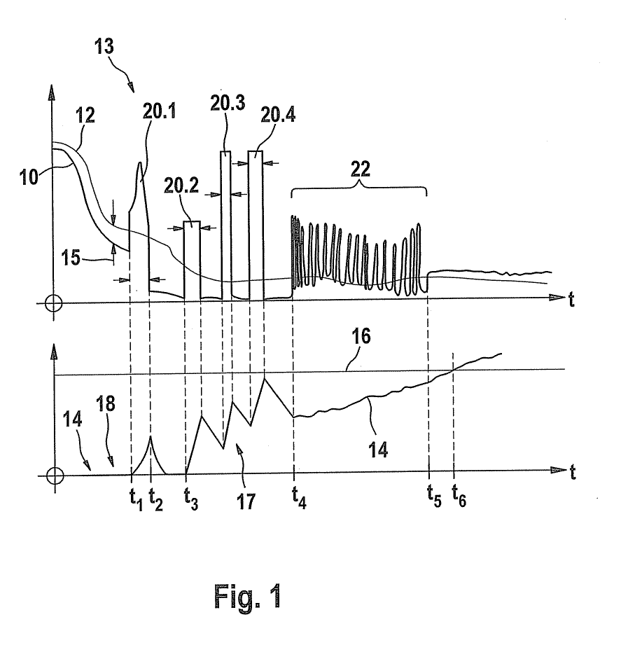

In an upper timing diagram, FIG. 1 shows an operating variable 10 of an engine of a vehicle or a signal characterizing operating variable 10, together with a limiting value 12 provided for operating value 10. Operating variable 10 and limiting value 12 undergo a time change during the operation of the vehicle or during execution of the method according to the present invention. Operating variable 10 in this case is monitored continuously for the exceedance of limiting value 12. In the drawing in FIG. 1, operating variable 10 shows, among other things, four pulses 20.1 through 20.4, each of which temporarily exceeds limiting value 12 and thus characterizes an error state 13. A sum 14 or an integral of a difference 15 between operating variable 10 and limiting value 12 is plotted in a lower diagram. A horizontal line characterizes a threshold value 16. A time axis t has the same scale for both diagrams and is located on the abscissa of the timing diagram concerned. Vertical broken lines represent the time reference of both diagrams for significant events.

Operating variable 10 is located below limiting value 12, starting from a random time zero point up to a point in time t1. Difference 15 between operating variable 10 and limiting value 12 is therefore negative. Operating variable 10 is continuously added to sum 14, and limiting value 12 is continuously subtracted from sum 14. This is equivalent to continuously adding difference 15 to sum 14. Because sum 14 would be negative up to point in time t1, sum 14 is limited to a lower threshold value 18 up to point in time t1. In FIG. 1, lower threshold value 18 is set to zero.

At a point in time t1, the operating variable undergoes a first pulse-like increase (pulse 20.1), limiting value 12 being exceeded. Sum 14 is positive starting at point in time t1 and increases as long as operating variable 10 lies above limiting value 12.

Starting at a point in time t2, operating variable 10 drops below limiting value 12, sum 14 being reduced. The amount of the increase or decrease of sum 14 depends on the degree to which operating variable 10 exceeds or drops below limiting value 12 as well as on an integration constant which characterizes an implicit debounce time 17.

Starting at a point in time t3, additional pulses 20.2, 20.3 and 20.4 occur, which in the present case are constituted in terms of their amplitude, duration and time interval in such a way that sum 14 essentially increases.

In an interval between point in time t4 and a point in time t5, the signal characterizing operating variable 10 undergoes multiple pulse-like interruptions 22. During this interval, sum 14 rises comparatively slowly.

Starting at point in time t5, operating variable 10 exceeds limiting value 12 by a small amount for a longer time segment, which causes sum 14 to increase further. At a point in time t6, sum 14 exceeds threshold value 16. This exceedance is evaluated as an error.

Although operating variable 10 substantially falls below limiting value 12 between pulses 20.1 through 20.4 in each case, error state 13 illustrated in FIG. 1 may therefore be evaluated as an “error” at point in time t6, using the present integration. This error may be displayed to a driver of a vehicle and/or countermeasures may be taken during the course of troubleshooting.

It is understood that the present continuous integration is provided only by way of example. In a comparable manner, the integration may also be carried out in a time-quantized and/or value-quantized manner with the aid of sampling (not illustrated). In this case, it is beneficial if the sampling rate is at least twice as high as a maximum expected rate of change of operating variable 10 or of limiting value 12; thus, sampling is carried out according to Shannon's Theorem. In this way, the integration may be carried out, for example, using a forward-backward counter, which may also be implemented by memory cells of a computer memory (RAM) which is written and read by a processor.

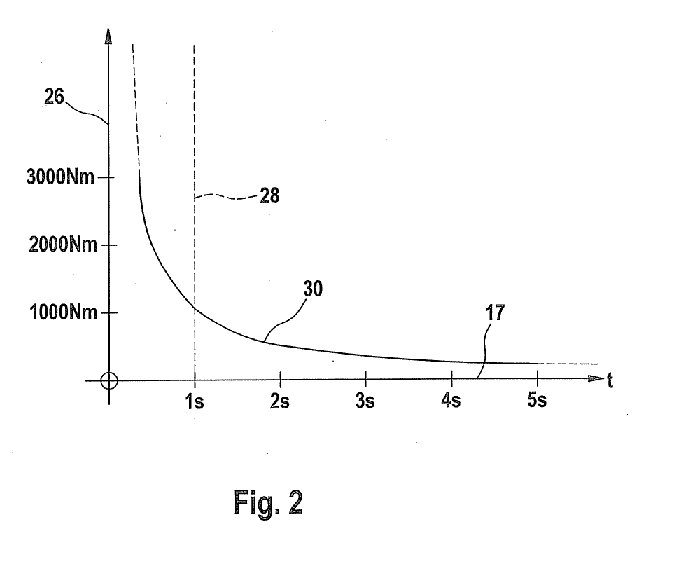

FIG. 2 shows a correlation between an exceedance 26 of a limiting value 12 of a torque of an engine and a debounce time 17. Similarly to FIG. 1, debounce time 17 is implemented implicitly as an integration constant and is plotted on the abscissa of the illustrated coordinate system. Exceedance 26 of the torque of the engine is plotted on the ordinate in Nm (newton meters). A vertically broken line 28 identifies a fixed explicit debounce time of one second in the present case. A curve 30 represents the correlation between implicit debounce time 17 and exceedance 26. In the present case, curve 30 follows the formula:

Y=(1,000 Nm)/X, where

X=debounce time 17 in seconds; and
Y=exceedance 26.

It is apparent that the debounce time according to the above formula is less than one second for all exceedances 26 of more than 1,000 Nm. Thus, the greater exceedance 26 is, the smaller is the time within which the error state may be evaluated as an error or an event. As a result, the time for detecting errors according to the function illustrated in FIG. 2 for all exceedances 26 of more than 1,000 Nm is shorter than the debounce time provided explicitly by way of example, i.e., an error state is evaluated correspondingly faster as an error.

Although debounce time 17 is longer for exceedances 26 of less than 1,000 Nm, at the same time the reliability is greater than would be the case when using only a fixed, predefined debounce time. In particular, it is possible to prevent just a few temporary exceedances 26 of limiting value 12 from being erroneously evaluated as an error throughout the entire illustrated range of curve 30 and likewise to prevent the evaluation of an error when limiting value 12 temporarily drops a few times.

For example, if one assumes a reliable limiting torque (limiting value) of 2,500 Nm, an exceedance of the limiting torque by 100% corresponds to a value of 2,500 Nm. This may be evaluated as an error after a debounce time of 0.4 seconds. An exceedance of the limiting torque by only 25% corresponds to a value of 625 Nm and, on the other hand, may be evaluated as an error after a debounce time of only 1.6 seconds.

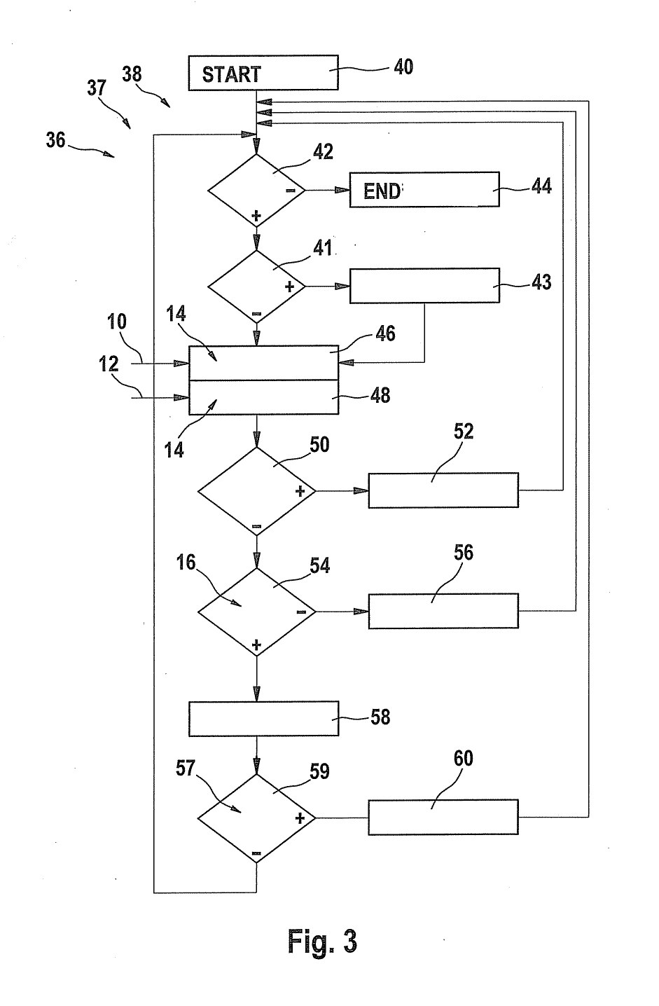

FIG. 3 shows a flow chart of method steps of a possible sequence of a specific embodiment of the method according to the present invention which is provided and executed, for example, in the form of a computer program 36 in a control unit 38. Computer program 36, a memory medium 27 and control unit 38 are indicated in FIG. 3 only by their reference numerals. In the drawing, the flow chart is essentially processed from top to bottom. The error detection procedure begins in a start block 40. A query in query block 42 checks whether the procedure should be continued. If not, the procedure branches to an end block 44.

A query in a query block 41 checks whether a variable characterizing operating variable 10 is greater than a variable characterizing limiting value 12. If this is the case, a constant variable is formed in a block 43 and added to sum 14 in a block 46. The variable characterizing operating variable 10 is also added to sum 14 in block 46, and the variable characterizing limiting value 12 is subtracted from sum 14 in a block 48. The addition and subtraction operations are carried out simultaneously or immediately following each other.

A query in a block 50 checks whether sum 14 is negative. In this case, sum 14 is set to zero in a block 52, and the method continues immediately after start block 40. If sum 14 is greater than zero, a query in query block 54 determines whether sum 14 has exceeded threshold value 16. If this is not the case, a possible error evaluation is reset in a block 56, and the method continues after start block 40. However, if threshold value 16 is exceeded, an error evaluation of operating variable 10 is carried out in a block 58, i.e., operating variable 10 is detected as being faulty.

Finally, sum 14 is compared with an upper limit 57 in a query block 59. Upper limit 57 lies above threshold value 16 and prevents sum 14 from increasing without limitation. If no upper limit 57 is provided, sum 14 would be able to assume any value with the consequence that, when the faulty state disappears, a reset of the error evaluation via query block 54 would cause a delay of indeterminate length. It is understood that the procedure described in FIG. 3 may be interrupted or resumed at any time by control unit 38.

What is claimed is:

1. A method for detecting errors in a control unit for at least one of controlling and regulating an engine in a vehicle, the method comprising:
detecting a faulty state of at least one of the engine and the vehicle;
forming, multiple times, a difference between at least one instantaneous value of an operating variable and a limiting value provided for this operating variable;
adding the formed differences to a sum; and
evaluating the faulty state as an error if the sum exceeds a predefinable threshold value.

2. The method of claim 1, wherein the threshold value is selected as a function of the operating variable.

3. The method of claim 1, wherein a debounce time is predefined, and wherein the faulty state is evaluated as an error after expiration of the debounce time.

4. The method of claim 1, wherein the limiting value is varied.

5. The method of claim 1, wherein the operating variable is at least one of a torque, a pressure, an exhaust gas value, an engine speed, an engine performance, a temperature, a metered fuel quantity, and a fuel injection activation time.

6. The method of claim 1, wherein a variable characterizing the operating variable is added to a counter content, and wherein a variable characterizing the limiting value is subtracted from the counter content.

7. The method of claim 1, wherein a constant is continuously added to the sum when the operating variable exceeds the limiting value.

8. The method of claim 1, wherein the sum is limited to the lower threshold value if the sum falls below a lower threshold value.

9. A computer readable medium having a computer program, which is executable on a control unit, comprising:
a program code arrangement having program code for detecting errors in a control unit for at least one of controlling and regulating an engine in a vehicle, by performing the following:
detecting a faulty state of at least one of the engine and the vehicle;
forming, multiple times, a difference between at least one instantaneous value of an operating variable and a limiting value provided for this operating variable;
adding the formed differences to a sum; and
evaluating the faulty state as an error if the sum exceeds a predefinable threshold value.

10. The computer readable medium of claim 9, wherein a variable characterizing the operating variable is added to a counter content, and wherein a variable characterizing the limiting value is subtracted from the counter content.

11. A control unit in a vehicle for detecting errors in a control unit for at least one of controlling and regulating an engine in a vehicle, the method comprising:
a detecting arrangement to detect a faulty state of at least one of the engine and the vehicle;
a forming arrangement to form, multiple times, a difference between at least one instantaneous value of an operating variable and a limiting value provided for this operating variable;
an adding arrangement to add the formed differences to a sum; and
an evaluating arrangement to evaluate the faulty state as an error if the sum exceeds a predefinable threshold value.
